(19) United States
(12) Patent Application Publication
(10) Pub. No.: US 2025/0375327 A1
(43) Pub. Date: Dec. 11, 2025

(54) MOBILITY CHAIR WITH ACCESSIBILITY FEATURES

(71) Applicant: Haresh Desai, Biloxi, MI (US)

(72) Inventor: Haresh Desai, Biloxi, MI (US)

(21) Appl. No.: 18/736,249

(22) Filed: Jun. 6, 2024

(51) Int. Cl. A61G 5/10; A61G 7/10

(52) U.S. Cl. CPC A61G 5/1002; A61G 5/1059; A61G 5/1067; A61G 7/1007

(57) ABSTRACT

A mobility chair described herein can comprise a base section, a set of wheels connected to the base section to allow the base section to traverse a surface, a chair section connected to the base section, the chair section comprising a seat portion pivotably connected to the base section and a backrest portion pivotably connected to the seat portion, and an actuator system configured to move the seat portion relative to the base section and move the backrest portion relative to the seat portion. A method described herein of lifting a user from a mobility chair onto a surface can comprise pivoting a seat portion of a chair section relative to a base section, elevating the seat portion relative to the base section, and reclining a backrest portion of the chair section relative to the seat portion.

### TECHNICAL FIELD

This document pertains generally, but not by way of limitation, to accessibility chairs, such as wheelchairs. More specifically, but not by way of limitation, the present application relates to accessibility chairs that can facilitate autonomous operation of the user.

### BACKGROUND

Accessibility chairs, such as wheelchairs, provide a user with the ability to move around while seated in the chair. For example, wheels can be pushed by the arms of the user to wheel the chair about. Additionally, for users unable to provide motive force on their own, electrically powered wheelchairs provide motive force without effort from the user. As such, wheelchairs provide the user with the ability to move about autonomously without the help of others, which provides some level of freedom.

### OVERVIEW

However, such autonomy and freedom typically only come after the user is seated in the chair. Many patients benefit from or require the assistance of another person to enter and exit the chair. The inability to enter or exit the chair at the will of the user can be expensive and burdensome. For example, the expense of hiring a caretaker to provide assistance for entering and exiting the chair can be costly. Additionally, reliance on a friend or family member can be burdensome to that person. Furthermore, only being able to enter and exit the chair at predetermined times can be inconvenient for the user. Specifically, waiting on another person to help with entering and exiting the chair can cause discomfort for the user, particularly at times when the user needs to use a toilet or go to sleep.

The present inventor has recognized, among other things, that problems to be solved in accessibility chairs can include the inability of the user to exit or enter the chair at one's own volition, particularly from a reclined position, such as from a bed. Many wheelchairs require the user to be seated upright when in the chair. Thus, the shape of the chair, including shapes of the backrest, armrests and footrests, can make positioning oneself for entry into or exit from the chair difficult. For a user to move from a seated position outside the chair to a seated position in the chair would require the user to contort their own body in such a way that is not possible for many wheelchair users that lack upper body and lower leg strength. Thus, the inability to enter and exit a wheelchair on one's own typically requires the assistance of another person, which can be difficult to obtain at certain times of the day, such as early morning or late at night when it is typical to be leaving or entering a bed or using a washroom and toilet.

The present subject matter can help provide solutions to these problems and other problems, such as by providing a wheelchair that can allow a user to exit and enter at their own leisure. Furthermore, the wheelchairs of the present disclosure can allow a user to utilize a toilet without leaving the chair. As such, the wheelchairs of the present disclosure can greatly increase the autonomy and freedom of a user.

In an example, a mobility chair can comprise a base section, a set of wheels connected to the base section to allow the base section to traverse a surface, a chair section connected to the base section, the chair section comprising a seat portion pivotably connected to the base section and a backrest portion pivotably connected to the seat portion, and an actuator system configured to move the seat portion relative to the base section and move the backrest portion relative to the seat portion.

In another example, a method of lifting a user from a mobility chair onto a surface can comprise pivoting a seat portion of a chair section relative to a base section, elevating the seat portion relative to the base section, and reclining a backrest portion of the chair section relative to the seat portion.

This overview is intended to provide an overview of subject matter of the present patent application. It is not intended to provide an exclusive or exhaustive explanation of the subject matter described herein. The detailed description is included to provide further information about the present patent application.

### BRIEF DESCRIPTION OF THE DRAWINGS

FIG. 1 is a perspective view of an example mobility chair of the present disclosure comprising a mobile base section and a chair section having an adjustable height seat portion and an adjustable incline backrest portion.

FIG. 2 is a perspective view of the mobility chair of FIG. 1 in a fully extended state, wherein the seat portion is fully raised, and the backrest portion is fully reclined.

FIG. 3A is a schematic illustration of a base section suitable for use with the mobility chair of FIG. 1 and FIG. 2.

FIG. 3B is a schematic illustration of a chair section suitable for use with the mobility chair of FIG. 1 and FIG. 2.

FIG. 4A is a perspective view of the mobility chair of FIG. 1 and FIG. 2 in a reclined position.

FIG. 4B is a perspective view of the mobility chair of FIG. 4A with the seat portion raised and the backrest portion in a horizontal position.

FIG. 4C is a perspective view of the mobility chair of FIG. 4B with the backrest portion extended beyond horizontal to contact a bed surface.

FIG. 5 is a perspective view of the mobility chair of FIG. 1 through FIG. 4C with the addition of an adjustable leg and foot support in a retracted position.

FIG. 6 is a perspective view of the mobility chair of FIG. 5 with the adjustable leg and foot support in an extended position.

FIG. 7 is a schematic illustration of portions of an example mobility chair of the present disclosure showing connection points between a base section and a seat portion for linkages.

FIG. 8 is a schematic illustration of portions of an example mobility chair of the present disclosure showing connection points between a base section and a seat portion for an actuator.

FIG. 9 is a schematic illustration of portions of an example mobility chair of the present disclosure showing a base section surrounding a toilet.

FIG. 10 is a schematic illustration of an electrical system of an example mobility chair of the present disclosure showing motors, actuators, a battery, a controller and a user interface.

FIG. 11 is a schematic illustration of an example mobility chair of the present disclosure comprising another configuration, leg supports, a bedpan and stabilizer tubes.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

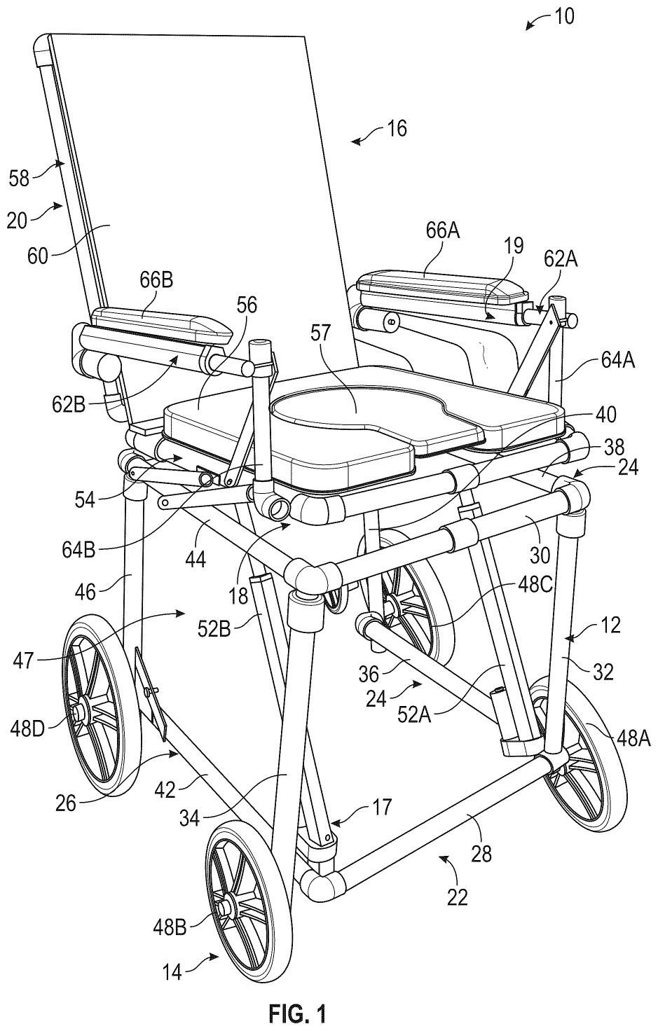

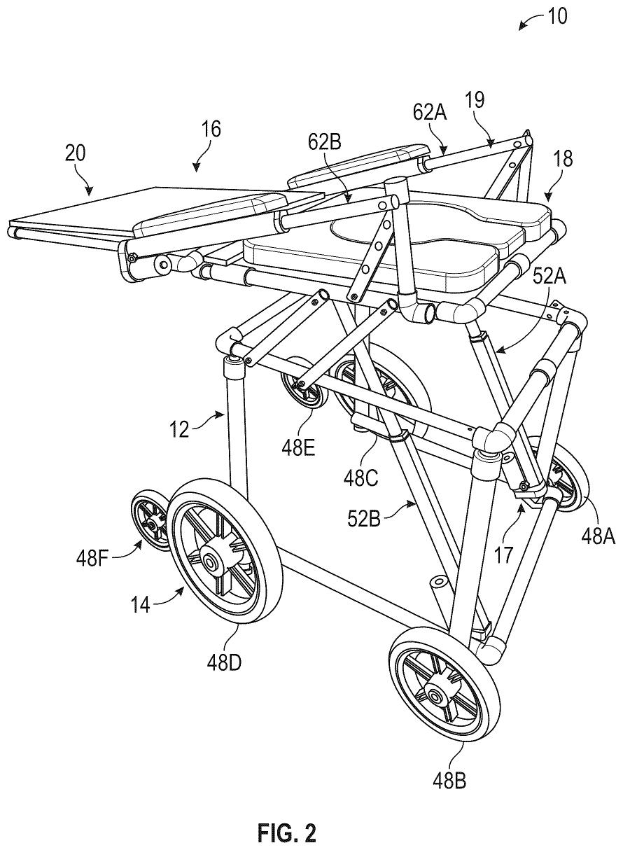

FIG. 1 is a schematic illustration of mobility chair 10 of the present disclosure comprising base section 12 having wheels 14 and chair section 16 having seat portion 18 and backrest portion 20. Seat portion 18 can be adjustably connected to base section 12 and backrest portion 20 can be adjustably connected to seat portion 18. FIG. 1 shows mobility chair in a fully retracted state. FIG. 2 is a perspective view of mobility chair 10 of FIG. 1 in a fully extended state, wherein seat portion 18 is fully raised and backrest portion 20 is fully reclined. FIG. 1 and FIG. 2 are discussed concurrently.

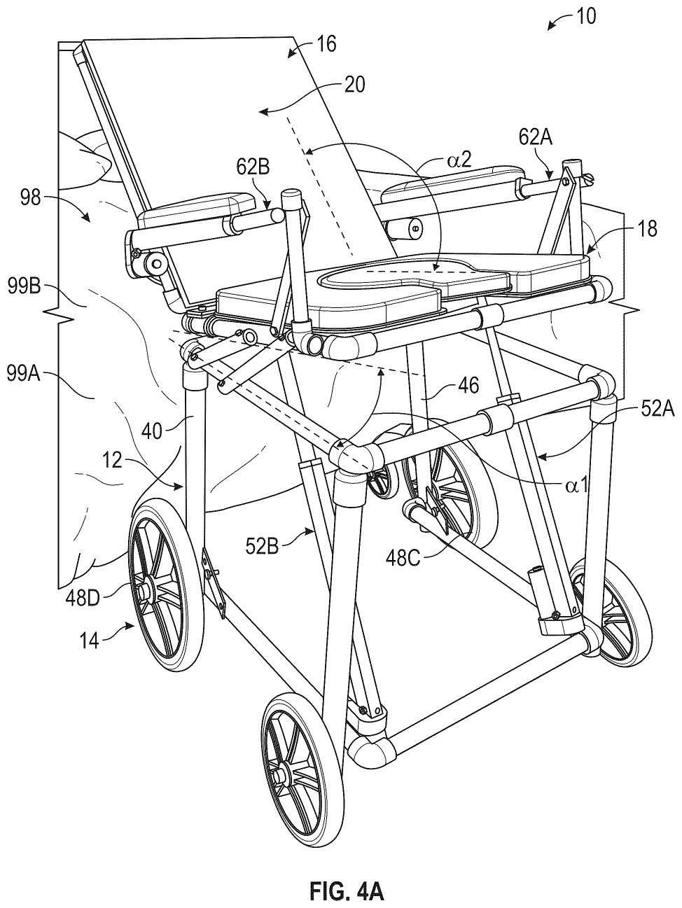

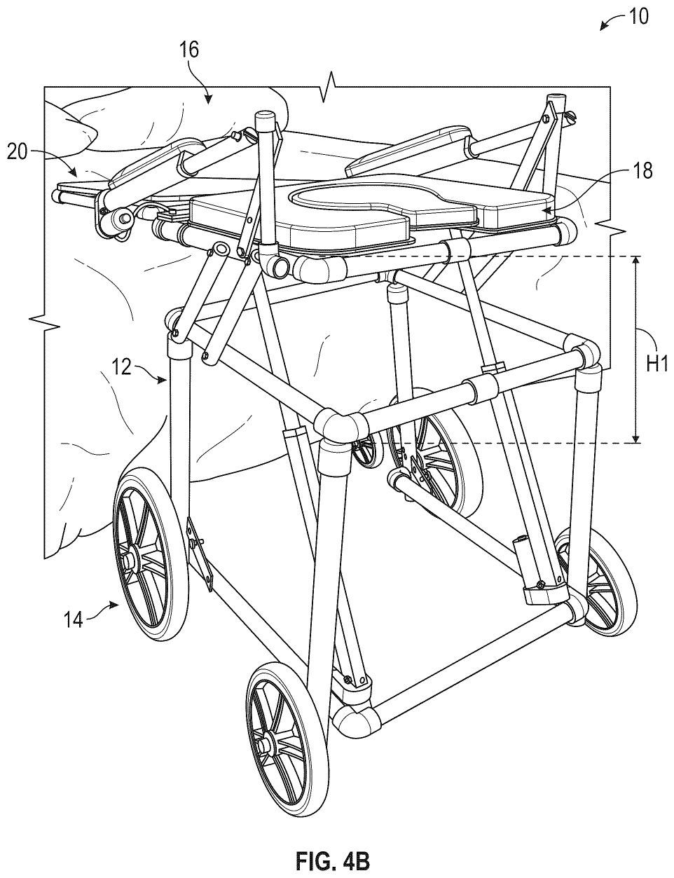

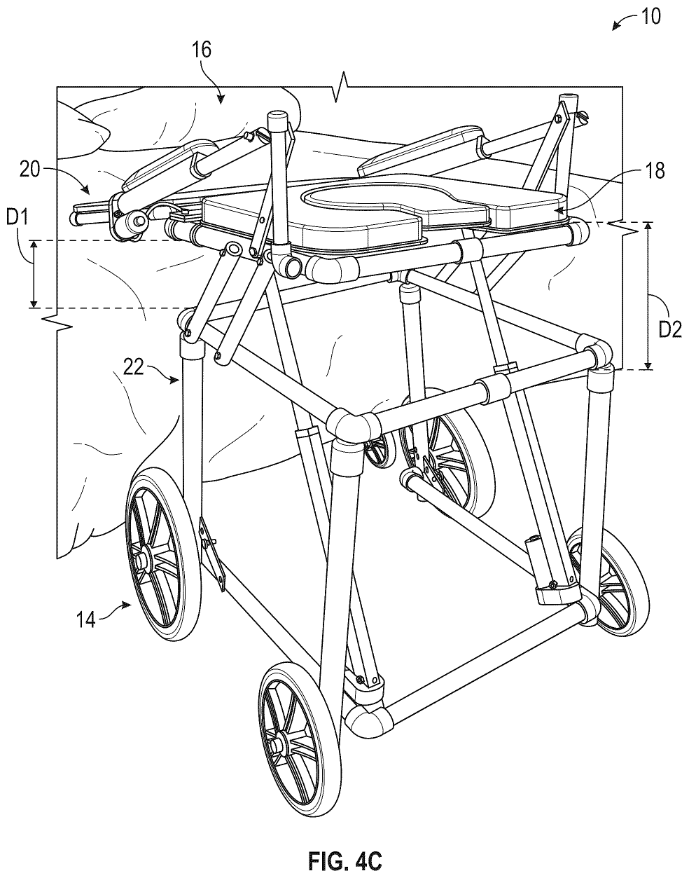

Base section 12 can be connected to chair section 16 by actuator system 17. Seat portion 18 can be connected to backrest portion 20 by actuator system 19. As discussed herein, actuator system 17 and actuator system 19 can be employed to change the shape of mobility chair 10 from a retracted or contracted position to an extended or deployed position to facilitate egress and ingress of a user from an elevated platform such as a bed. In particular, actuator system 17 can be used to raise and pivot chair section 16 relative to base section 12, and actuator system 19 can be used move the position of backrest portion 20 relative to seat portion 18. Thus, mobility chair 10 can be configured to move a patient between a typical seated position to a fully reclined position. In particular, mobility chair 10 can be wheeled to a location where backrest portion 20 faces toward a bed and base section 12 engages a side of the bed. Thereafter, backrest portion 20 can be reclined to rest on top of the bed to allow the user can slide themselves off of mobility chair 10 onto the bed and vice versa using their arms, thereby eliminating the need for assistance from another portion or reducing the input from another person, as is shown in FIG. 4A through FIG. 4C. As such, mobility chair 10 can include accessibility features for using, e.g., entering and leaving, a bed structure.

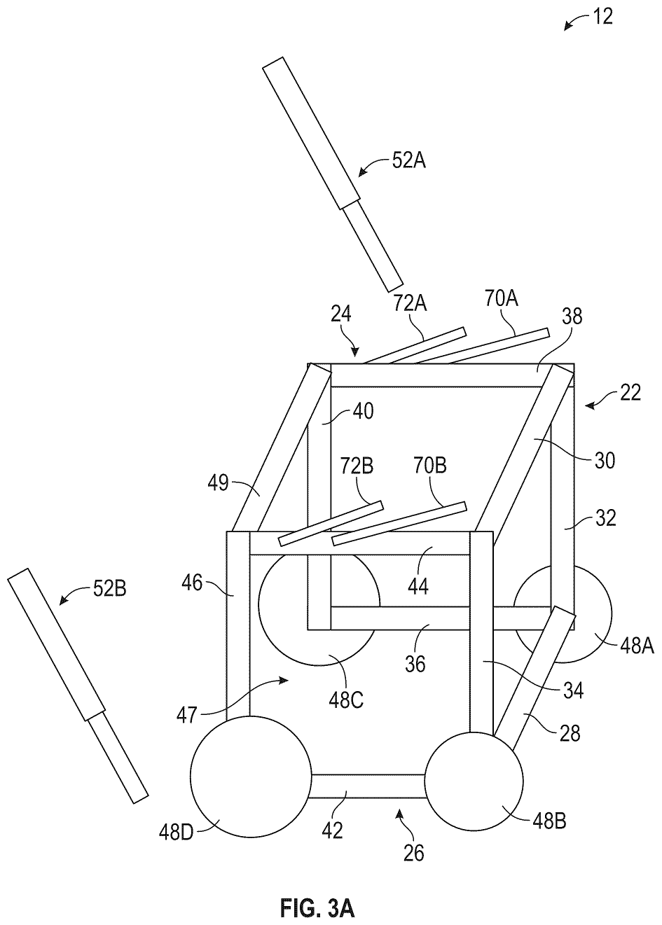

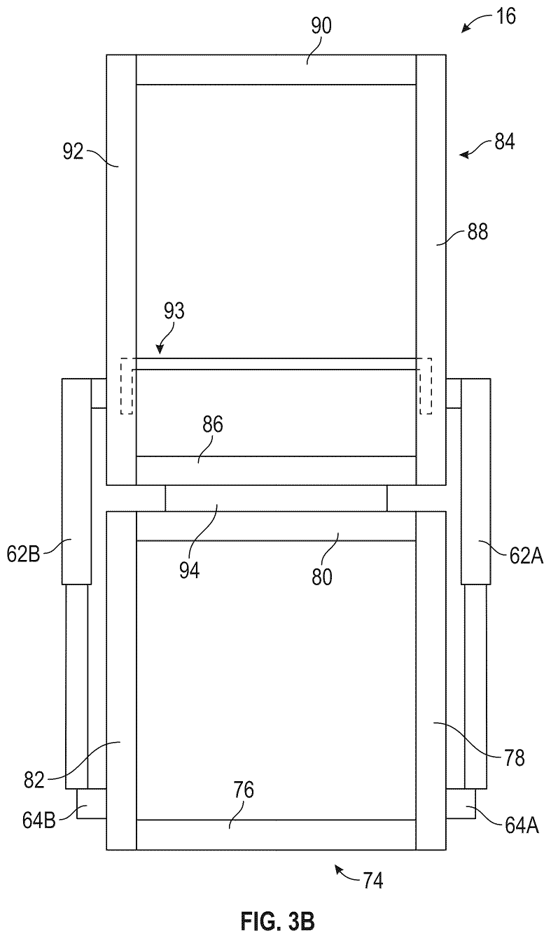

As is discussed in greater detail with reference to FIG. 3A, base section 12 can comprise front panel 22, left-side panel 24 and right-side panel 26. Front panel 22 can comprise bottom bar 28, top bar 30, left bar 32 and right bar 34. Left-side panel 24 can comprise bottom bar 36, top bar 38 and rear bar 40. Right-side panel 26 can comprise bottom bar 42, top bar 44 and rear bar 46. Front panel 22, left-side panel 24 and right-side panel 26 can form interior or internal space 47. Wheels 14 can comprise wheel 48A, wheel 48B, wheel 48C and wheel 48D. Furthermore, as can be seen in FIG. 2, wheels 14 can include tilt wheel 48E and tilt wheel 48F. Actuator system 17 can comprise left-side actuator 52A and right-side actuator 52B.

As is discussed in greater detail with reference to FIG. 3B, seat portion 18 can comprise seat frame 54 and seat pad 56. Seat pad 56 can include toilet insert 57. Backrest portion 20 can comprise backrest frame 58 and back pad 60. Actuator system 19 can comprise left-side actuator 62A and right-side actuator 62B. Arm support 64A and arm support 64B can extend from seat frame 54, such as in a vertical orientation. Left-side actuator 62A can extend between backrest frame 58 and arm support 64A. Arm pad 66A can be positioned on left-side actuator 62A. Right-side actuator 62B can extend between backrest frame 58 and arm support 64B. Arm pad 66B can be positioned on right-side actuator 62B. Thus, left-side actuator 62A and arm pad 66A can form a first armrest and right-side actuator 62B and arm pad 66B can form a second armrest.

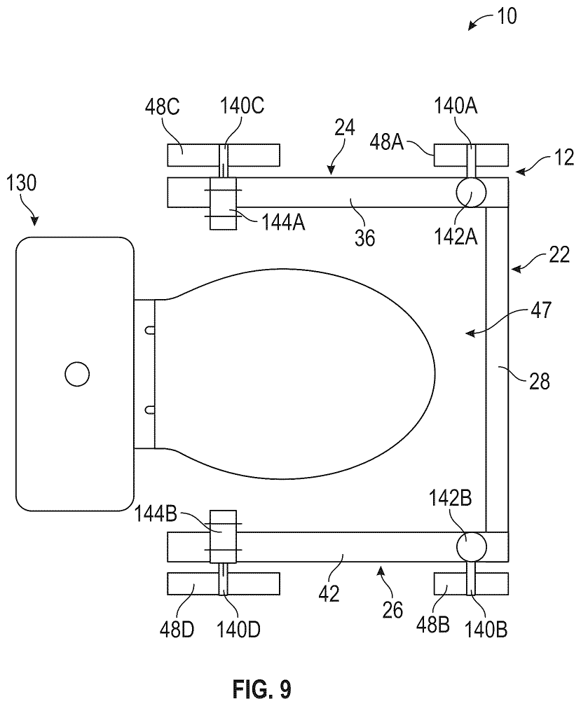

FIG. 3A is a schematic illustration of base section 12 suitable for use with mobility chair 10 of FIG. 1 and FIG. 2. Base section 12 can comprise a frame configured to elevate chair section 16 (FIG. 3B) above ground level. Base section 12 can form a six-sided cuboid. In examples, base section 12 can form a cube where each face is approximately the same size. In examples, front panel 22 can be wider than left-side panel 24 and right-side panel 26 to facilitate placement in front of a toilet, as shown in FIG. 9. In examples, base section 12 can be formed of eleven structural members extending along the edges of the cube, except for between wheel 48C and wheel 48D. Bottom bar 28 and top bar 30 can provide structural rigidity between left-side panel 24 and right-side panel 26. Similarly, top bar 49 can provide structural rigidity between left-side panel 24 and right-side panel 26. However, a connecting piece can be omitted between rear bar 40 and rear bar 46 to allow for the passage of objects into internal space 47, such as a toilet as shown in FIG. 9.

Bottom bar 28, top bar 30, left bar 32 and right bar 34 of front panel 22, bottom bar 36, top bar 38 and rear bar 40 of left-side panel 24, and bottom bar 42, top bar 44 and rear bar 46 or right-side panel 26 can be formed of materials that provide, rigidity, strength and light weight, such as PVC pipe and aluminum tubes. The bars of base section 12 can be connected by any suitable means, such as fasteners, e.g., threaded fasteners, and metallurgical bonding, e.g., welding.

Base section 12 can provide structure for mounting of wheels 14 (FIG. 1) to allow base section 12 to be moved about or traverse a surface. Mobility chair 10 can be configured to move about a surface to provide transportation for a user. Wheels 14 can engage a surface to allow base section 12 to move about. In the illustrated example, mobility chair 10 can include four wheels, wherein wheel 48A and wheel 48B are located in front left and front right locations, and wheel 48C and wheel 48D are located in rear left and rear right locations. In examples, wheel 48C and wheel 48D can be larger than wheel 48A and wheel 48B. As discussed with reference to FIG. 9, wheel 48A and wheel 48B can be configured to rotate to provide steering capabilities to mobility chair 10. Furthermore, as discussed with reference to FIG. 9, wheel 48C and wheel 48D can be connected to motors to provide propulsion to mobility chair 10. Note, tilt wheel 48E and tilt wheel 48F are omitted from FIG. 3A for simplicity.

Left-side actuator 52A and right-side actuator 52B are shown exploded from base section 12 in FIG. 3A for clarity. Lower ends of left-side actuator 52A and right-side actuator 52B can be connected to base section 12 via various means. In examples, left-side actuator 52A and right-side actuator 52B can be connected to bottom bar 28. Upper ends of left-side actuator 52A and right-side actuator 52B can be connected to seat portion 18. In examples, left-side actuator 52A and right-side actuator 52B can be connected to left bar 78 (FIG. 3B) and right bar 82 (FIG. 3B), respectively.

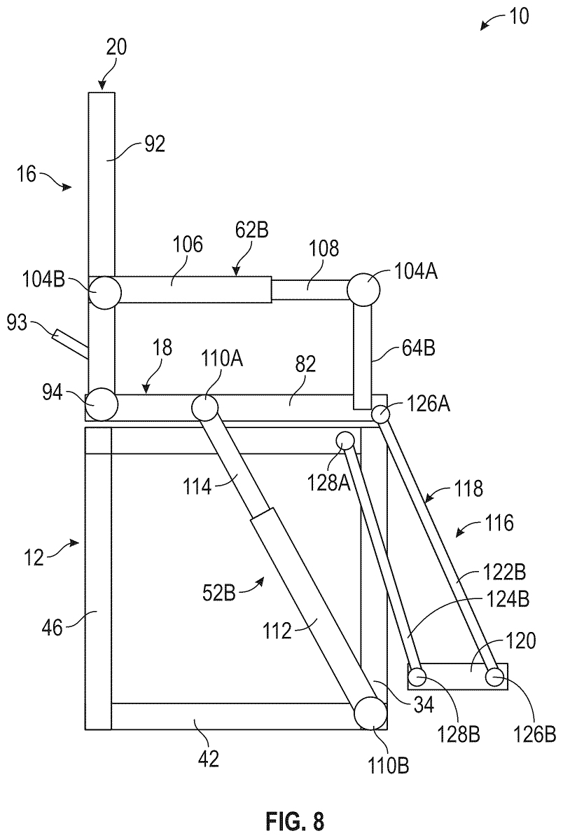

As discussed with reference to FIG. 8, left-side actuator 52A and right-side actuator 52B can be connected via pivoting connectors that allow left-side actuator 52A and right-side actuator 52B to pivot in planes parallel to left-side panel 24 and right-side panel 26, e.g., in a sagittal plane. Left-side actuator 52A and right-side actuator 52B can comprise devices configured to have adjustable lengths to push and pull seat portion 18 away from and towards base section 12. In examples, left-side actuator 52A and right-side actuator 52B can comprise electrically activated linear actuators wherein an electric motor can drive a worm gear to push and pull an actuator rod. In examples, left-side actuator 52A and right-side actuator 52B can comprise electrically activated lead screws.

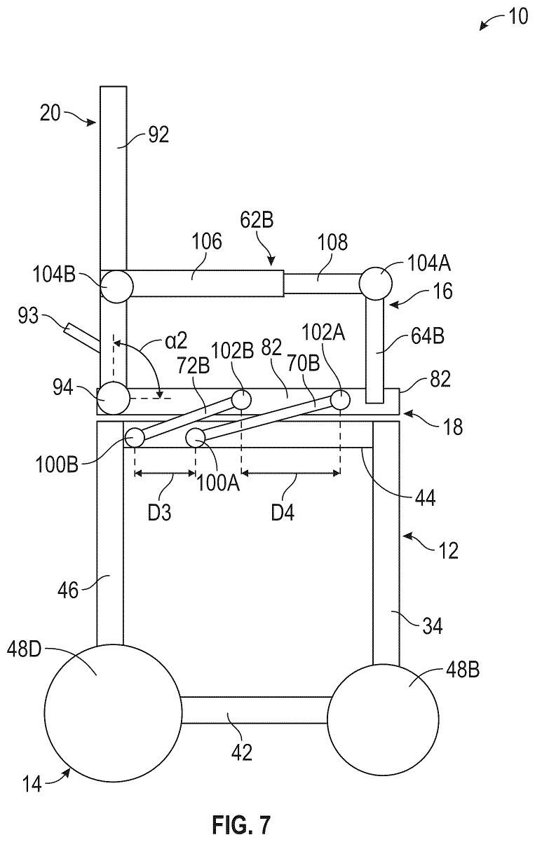

Base section 12 can include forward linkage 70A, rear linkage 72A, forward linkage 70B and rear linkage 72B. Forward linkage 70A, rear linkage 72A, forward linkage 70B and rear linkage 72B can comprise a pivot mechanism. Forward linkage 70A and rear linkage 72A can be connected to top bar 38, and forward linkage 70B and rear linkage 72B can be connected to top bar 44. Forward linkage 70A, rear linkage 72A, forward linkage 70B and rear linkage 72B can be configured to provide structural rigidity for supporting seat portion 18. Forward linkage 70A, rear linkage 72A, forward linkage 70B and rear linkage 72B can be formed of materials that provide, rigidity, strength and light weight, such as PVC pipe and aluminum tubes. Forward linkage 70A, rear linkage 72A, forward linkage 70B and rear linkage 72B can be connected to top bar 38 and top bar 44 by any suitable means that provides a rotational coupling, such as fasteners, pinned connections, hinges and the like, as discussed with reference to FIG. 7. As discussed in greater detail with reference to FIG. 3B, forward linkage 70A, rear linkage 72A, forward linkage 70B and rear linkage 72B can additionally be connected to chair section 16 in a pivotable or rotational manner.

FIG. 3B is a schematic illustration of chair section 16 suitable for use with the mobility chair of FIG. 1 and FIG. 2. Seat portion 18 can comprise seat frame 74 having front bar 76, left bar 78, top bar 80 and right bar 82. Backrest portion 20 can comprise back frame 84 having front bar 86, left bar 88, top bar 90 and right bar 92. Back frame 84 can additionally comprise support 93, which can additionally or alternatively be connected to back pad 60 (FIG. 1). Arm support 64A can extend from left bar 78 and arm support 64B can extend from right bar 82. Arm support 64A and arm support 64B can be braced with other brackets or straps to increase the stability of mobility chair 10. Left-side actuator 62A can extend between left bar 78 and left bar 88, and right-side actuator 62B can extend between right bar 82 and right bar 92.

Seat frame 74 can be configured to provide structural rigidity for supporting seat pad 56 (FIG. 1). Front bar 76, left bar 78, top bar 80 and right bar 82 can be formed of materials that provide, rigidity, strength and light weight, such as PVC pipe and aluminum tubes. The bars of seat portion 18 can be connected by any suitable means, such as fasteners, e.g., threaded fasteners, and metallurgical bonding, e.g., welding.

Back frame 84 can be configured to provide structural rigidity for supporting back pad 60 (FIG. 1). Support 93 can extend from back frame 84 to provide support for back frame 84 when backrest portion 20 is in the reclined position to engage a bed, as shown in FIG. 4C. Support 93 can comprise a U-shaped bar or other structure to prevent or inhibit bending of back frame 84 and back pad 60. For example, support 93 can comprise two short members, e.g., bars, rods or tubes, extending from left bar 88 and right bar 92 and a third cross-member connecting the other two short members. The third cross-member can be straight or flat to engage flush with a flat surface, such as an upper surface of a mattress or bed. Front bar 86, left bar 88, top bar 90 and right bar 92, as well as support 93, can be formed of materials that provide, rigidity, strength and light weight, such as PVC pipe and aluminum tubes. The bars of backrest portion 20 can be connected by any suitable means, such as fasteners, e.g., threaded fasteners, and metallurgical bonding, e.g., welding.

Back frame 84 can be joined to seat frame 74 via a rotational connector, such as one or more hinges. Specifically, hinge 94 can connect front bar 86 and top bar 80 to allow the angle, e.g., angle α2 of FIG. 7, between back frame 84 and seat frame 74 to vary. In examples, hinge 94 can comprise a hinge having a pair of leaves each having one or more knuckles or tubes through which a pin can be inserted.

Rear ends of left-side actuator 62A and right-side actuator 62B can be connected to backrest portion 20 via various means. In examples, left-side actuator 62A and right-side actuator 62B can be connected to left bar 88 and right bar 92, respectively. Upper ends of left-side actuator 62A and right-side actuator 62B can be connected to seat portion 18. In examples, left-side actuator 62A and right-side actuator 62B can be connected to arm support 64A and arm support 64B, respectively.

As discussed with reference to FIG. 7, left-side actuator 62A and right-side actuator 62B can be connected via pivoting connectors that allow left-side actuator 62A and right-side actuator 62B to pivot in planes parallel to left-side panel 24 and right-side panel 26, e.g., in a sagittal plane. Left-side actuator 62A and right-side actuator 62B can comprise devices configured to have adjustable lengths to push and pull backrest portion 20 away from and towards seat portion 18. In examples, left-side actuator 62A and right-side actuator 62B can comprise electrically activated linear actuators wherein an electric motor can drive a worm gear to push and pull an actuator rod. In examples, left-side actuator 62A and right-side actuator 62B can comprise electrically activated lead screws.

Chair section 16 can be connected to base section 12 in a pivoting manner that allows for both elevating and tilting. Forward linkage 70A and rear linkage 72A can connect left-side panel 24 and seat portion 18, and forward linkage 70B and rear linkage 72B can connect right-side panel 26 and seat portion 18. As discussed in greater detail with reference to FIG. 7, forward linkage 70A and rear linkage 72A can be closer together on left-side panel 24 than on seat portion 18, and forward linkage 70B and rear linkage 72B can be closer together on right-side panel 26 than on seat portion 18, thereby allowing left-side actuator 52A and right-side actuator 52B to initially pivot seat portion 18 relative to base section 12 (FIG. 4A) and subsequently push seat portion 18 away from base section 12 (FIG. 4B).

FIG. 4A is a perspective view of mobility chair 10 of FIG. 1 and FIG. 2 in a reclined position. FIG. 4B is a perspective view of mobility chair 10 of FIG. 4A with seat portion 18 raised and backrest portion 20 in a horizontal position. FIG. 4C is a perspective view of mobility chair 10 of FIG. 4B with backrest portion 20 extended beyond horizontal. FIG. 4A through FIG. 4C illustrate various states in the progression of mobility chair 10 from fully contracted to fully extended relative to structure 98, which can comprise a bed. Structure 98 can comprise side surface 99A and top surface 99B. FIG. 4A through FIG. 4C are discussed consecutively.

FIG. 4A shows left-side actuator 52A and right-side actuator 52B partially extended to rotate seat portion 18 relative to base section 12 to change angle α1. Likewise, FIG. 4A shows left-side actuator 62A and right-side actuator 62B partially extended to rotate backrest portion 20 relative to seat portion 18 to change angle α2. Mobility chair 10 can be backed-up in close proximity to or adjacent structure 98 so that a backside of base section 12 faces toward side surface 99A. In examples, mobility chair 10 can be positioned so that rear bar 40 and rear bar 46 are pushed-up against and engage side surface 99A. As such, tilt wheel 48E and tilt wheel 48F can be positioned underneath a bedframe, for example. In examples, wheel 48C and wheel 48D can be locked into their respective rotational positions to prevent undesired movement of mobility chair 10 away from structure 98 during egress or ingress of the user. In examples, wheel 48C and wheel 48D can be locked by locking motors connected to wheel 48C and wheel 48D, by activating separate locking devices, such as electric linear actuators that can extend pins into wheel 48C and wheel 48D to prevent rotation thereof, or by manually setting locking devices, such as frictional brakes and the like. FIG. 4A shows a first stage of extension of mobility chair 10 wherein chair section 16 remains in contact with base section 12 at the rear end as if connected by a hinge joint. Thus, a user seated within chair section 16 can begin to be tilted backward toward to top surface 99B. In examples, backrest portion 20 and seat portion 18 can be moved simultaneously, e.g., all of left-side actuator 52A, right-side actuator 52B, left-side actuator 62A and right-side actuator 62B can be operated at the same time. However, left-side actuator 52A and right-side actuator 52B can be operated at different times than left-side actuator 62A and right-side actuator 62B such that backrest portion 20 can be reclined toward top surface 99B first and then seat portion can be rotated relative to base section 12 second, or vice versa. FIG. 4B shows left-side actuator 52A and right-side actuator 52B fully extended to lift seat portion 18 away from and above base section 12 to change height h1. Likewise, FIG. 4B shows left-side actuator 62A and right-side actuator 62B further partially extended to rotate backrest portion 20 relative to seat portion 18 to change angle α2. FIG. 4B shows a second stage of extension of mobility chair 10 wherein chair section 16 is elevated to bring seat portion 18 up to and above the level of top surface 99B. Additionally, backrest portion 20 is reclined to be parallel or nearly parallel to seat portion 18. Thus, a user seated within chair section 16 can be leaned back proximate to top surface 99B. In examples, backrest portion 20 and seat portion 18 can be moved simultaneously, e.g., all of left-side actuator 52A, right-side actuator 52B, left-side actuator 62A and right-side actuator 62B can be operated at the same time. However, left-side actuator 52A and right-side actuator 52B can be operated at different times than left-side actuator 62A and right-side actuator 62B such that backrest portion 20 can be reclined toward top surface 99B first and then seat portion can be elevated from base section 12 second, or vice versa.

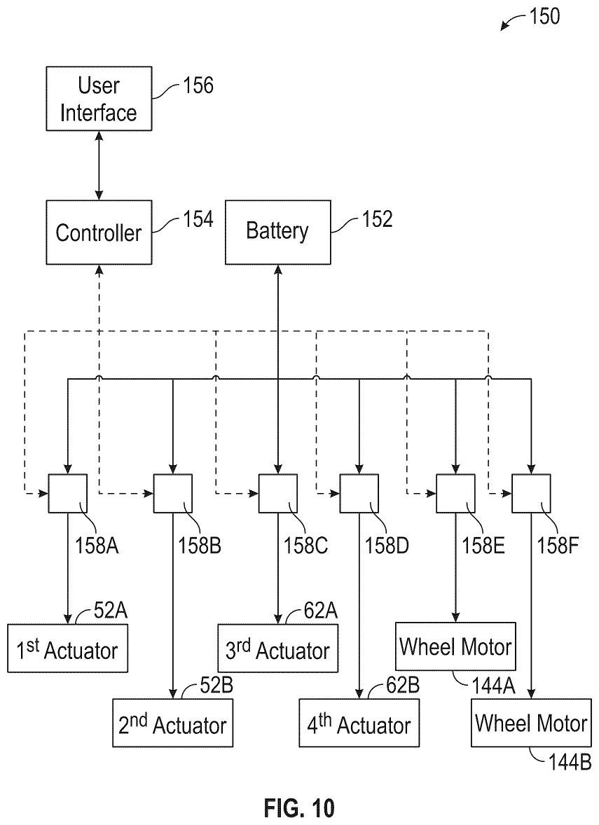

FIG. 4C shows left-side actuator 52A and right-side actuator 52B fully extended to lift seat portion 18 away from and above base section 12 to height h1, as shown in FIG. 4B. Likewise, FIG. 4C shows left-side actuator 62A and right-side actuator 62B fully extended to rotate backrest portion 20 relative to seat portion 18 to increase angle α2 so that backrest portion 20 is rotated past horizontal to be declined toward top surface 99B. For example, angle α2 can be greater than one-hundred-eighty degrees. Thus, backrest portion 20 can be in contact with top surface 99B. In examples, height h1 and angle α2 can be adjusted or controlled to accommodate different heights of top surface 99B. In examples, the actuators of mobility chair 10 (left-side actuator 52A, right-side actuator 52B, left-side actuator 62A and right-side actuator 62B) can be adjusted to provide maximum extension that can be matched to the specific bed of a user. For example, the amount that arm 108 extends from base 106 can be adjusted, and the amount that arm 114 extends from base 112 can be adjusted (FIG. 8). Thus, a user can utilize user interface 156 (FIG. 10) to fully extend or fully contract the actuators. However, in examples, the actuators of mobility chair 10 can be configured to elevate seat portion 18 to a height, e.g., thirty-six inches or more, to accommodate most bed structures and a user can utilize user interface 156 FIG. 10) to adjust the actuators to any intermediate state to accommodate a specific height of bed for each user. In examples, mobility chair 10 can include sensors to determine an appropriate height for seat portion 18. Output of the sensors can be used to provide automatic stopping points for the actuators or can provide an audio or visual alarm to a user to stop operation of the actuators. In examples, actuator system 17 and forward linkage 70A, rear linkage 72A, forward linkage 70B and rear linkage 72B, e.g., the pivot mechanism, can be configured to allow height H1 to vary such that distance D2 can be greater than distance D1 so that seat portion 18 is declined toward top surface 99B. Left-side actuator 52A and right-side actuator 52B can be configured to have capacities to lift the weight of a human being plus additional capacity. In examples, left-side actuator 52A and right-side actuator 52B can be configured to lift several hundred pounds, such as two hundred, three hundred or four hundred pounds.

FIG. 4C shows a third stage of extension of mobility chair 10 wherein chair section 16 is elevated to bring seat portion 18 up to and above the level of top surface 99B. Additionally, backrest portion 20 is declined to be past parallel with seat portion 18. A user seated within chair section 16 can be leaned back downward toward top surface 99B. Thus, the user can slide themselves along backrest portion 20 and seat portion 18 off mobility chair 10. For example, a user can use their arms to push against top surface 99B to cause their body to slide against backrest portion 20 and seat portion 18 and onto top surface 99B. Additionally, in the example of FIG. 8, a user can push their feet against footrest 120 to assist in sliding off seat portion 18. Support 93 (FIG. 3B) can extend from back frame 84 to provide support for back frame 84 when top bar 90 engages top surface 99B. For example, left bar 88 and right bar 92 of seat frame 74 can extend between top bar 90 and front bar 86, which can be supported by hinge 94 and top surface 99B. Support 93 can provide support to back frame 84 against top surface 99B, thereby accounting for backrest portion 20 being at a decline with top bar 90 being lower than front bar 86 and back frame 84 and back pad 60 not laying flush against top surface 99B.

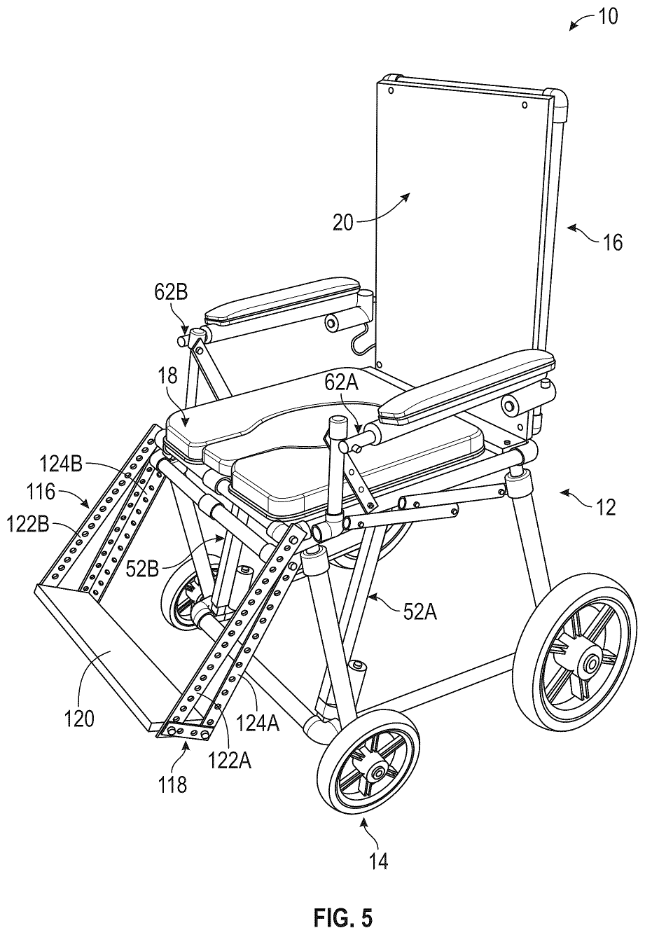

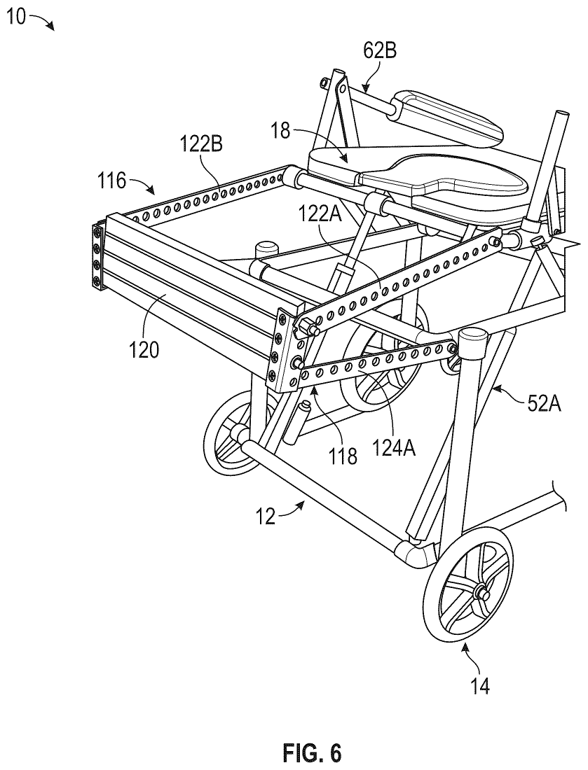

FIG. 5 is a perspective view of mobility chair 10 of FIG. 1 through FIG. 4C with the addition of adjustable leg support 116 in a retracted position. FIG. 6 is a perspective view of mobility chair 10 of FIG. 5 with adjustable leg support 116 in an extended position. FIG. 5 and FIG. 6 are discussed concurrently.

Adjustable leg support 116 can comprise coupling mechanism 118 and footrest 120. Coupling mechanism 118 can comprise first strut 122A, second strut 124A, first strut 122B and second strut 124B. First strut 122A, second strut 124A, first strut 122B and second strut 124B can provide coupling to both base section 12 and chair section 16 to provide stability to mobility chair 10 when in the extended position, but while also providing pivoting action. Thus, footrest 120 can be in an elevated position to allow the user to be oriented in a supine position to use their legs to push off on footrest 120.

Adjustable leg support 116 can be configured to lift footrest 120 upward and move footrest 120 away from base section 12 in a swinging motion as seat portion 18 is lifted above base section 12. Footrest 120 also adjust orientation from a horizontal foot-support surface to a vertical foot-support portion. In examples, footrest 120 can be provided with a heel pad to provide support for the back of the feet of a user when in the extended position. Each of first strut 122A, second strut 124A, first strut 122B and second strut 124B can be pivotably connected to footrest 120 at distal ends. However, proximal ends of first strut 122A and first strut 122B can be connected to seat portion 18 while proximal ends of second strut 124A and second strut 124B can be connected to base section 12. In particular, first strut 122A and first strut 122B can be connected to seat frame 74, such as at left bar 78 and right bar 82, respectively, and second strut 124A and second strut 124B can be connected to left-side panel 24 and right-side panel 26, respectively, such as at top bar 38 and top bar 44, respectively. Further discussion of the operation of adjustable leg support 116 is found with reference to FIG. 8.

FIG. 7 is a schematic illustration of portions of mobility chair 10 of the present disclosure showing connection point 100A, connection point 100B, connection point 102A and connection point 102B between base section 12 and seat portion 18 for forward linkage 70B and rear linkage 72B. Mobility chair 10 can include base section 12 and chair section 16. Base section 12 can have right bar 34, bottom bar 42, top bar 44 and rear bar 46. Wheel 48B and wheel 48D can be connected to base section 12. Chair section 16 can comprise seat portion 18 and backrest portion 20. Seat portion 18 can comprise right bar 82 and backrest portion 20 can comprise right bar 92. Seat portion 18 can further comprise right-side actuator 62B and arm support 64B. Backrest portion 20 can be connected to seat portion 18 at hinge 94. Right-side actuator 62B can be connected to arm support 64B at connection point 104A and right bar 92 at connection point 104B.

FIG. 7 represents connection points on the right side of mobility chair 10. Mobility chair 10 can additionally include connection points between corresponding components on the left side of mobility chair 10. Thus, the left side of mobility chair 10 can be a mirror image of the right side of mobility chair 10.

In examples, connection point 102A can comprise a pin extending through right bar 82 and forward linkage 70B, connection point 102B can comprise a pin extending through right bar 82 and rear linkage 72B, connection point 100A can comprise a pin extending through top bar 44 and forward linkage 70B, and connection point 100B can comprise a pin extending through top bar 44 and rear linkage 72B.

Connection point 100A and connection point 102A can allow forward linkage 70B to rotate relative to right bar 82 and top bar 44. Connection point 100B and connection point 102B can allow rear linkage 72B to rotate relative to right bar 82 and top bar 44. Connection point 100A can be spaced apart from connection point 100B on top bar 44 by distance D3. Connection point 102A can be spaced apart from connection point 102B on right bar 82 by distance D4. In examples, forward linkage 70B can be longer than rear linkage 72B. In examples, distance D4 can be greater than distance D3 in order to produce a two-stage actuation motion. The two-stage actuation motion can comprise first a pivoting motion and second a lifting motion. In additional examples, a two-stage actuation motion can be produced with two sets of actuators. For example, forward linkage 70A, rear linkage 72A, forward linkage 70B and rear linkage 72B, e.g., the pivot mechanism, can be replaced by one or more actuators that allow seat portion 18 to pivot relative to base section 12 via operation of left-side actuator 52A and right-side actuator 52B, and then that can be operated to lift seat portion 18 relative to base section 12.

Connection point 104A and connection point 104B can allow right-side actuator 62B to expand from the position illustrated in FIG. 7 to rotate backrest portion 20 leftward at hinge 94 to the position of FIG. 4C, for example. Right-side actuator 62B can comprise base 106 and arm 108. In examples, connection point 104A can comprise a pin extending through arm support 64B and arm 108, and connection point 104B can comprise a pin extending through right bar 92 and base 106. As backrest portion 20 rotates leftward, connection point 104A can allow arm 108 to pivot to come closer to arm support 64B such that the angle between arm support 64B and arm 108 decreases. Additionally, connection point 104B can allow base 106 to pivot to come closer to right bar 92 such that the angel between right bar 92 and base 106 decreases.

FIG. 8 is a schematic illustration of portions of mobility chair 10 of the present disclosure showing connection points 110A and connection point 110B between base section 12 and seat portion 18 for right-side actuator 52B.

Connection point 110A and connection point 110B can allow right-side actuator 52B to expand from the position illustrated in FIG. 8 to rotate and push seat portion 18 leftward and upward using forward linkage 70B and rear linkage 72B (FIG. 7). Right-side actuator 52B can comprise base 112 and arm 114. In examples, connection point 110A can comprise a pin extending through right bar 82 and arm 114, and connection point 110B can comprise a pin extending through bottom bar 42 and base 112. As seat portion 18 rotates leftward, connection point 110A can allow arm 114 to pivot to move further away from right bar 82 such that the angle between right bar 82 and arm 114 increases forward of connection point 110A. Additionally, connection point 110B can allow base 112 to pivot to come closer to bottom bar 42 such that the angle between bottom bar 42 and base 112 decreases rearward of connection point 110B. However, in examples, due to the configuration of forward linkage 70B and rear linkage 72B, e.g., their relative positions and lengths, operation of right-side actuator 52B can not cause any rotation at connection point 110A and connection point 110B, such as in the fully elevated position of FIG. 4B and FIG. 4C.

Additionally, the positioning of connection point 110A on right bar 82 relative to connection point 102A and connection point 102B can be controlled to facilitate lifting and tilting of chair section 16. For example, connection point 110A can be positioned between connection point 102A and connection point 102B. However, connection point 110A can be positioned in front of connection point 102A or behind connection point 102B.

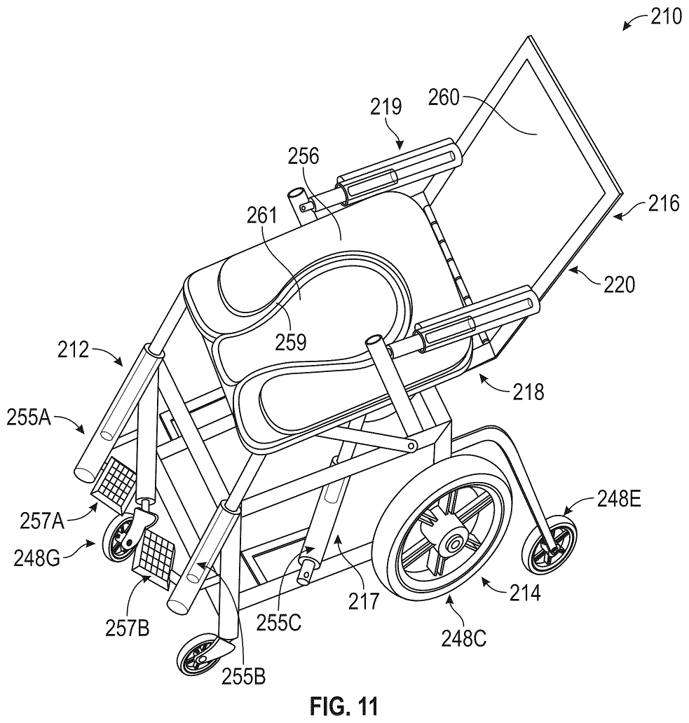

FIG. 8 additionally shows adjustable leg support 116, which can comprise coupling mechanism 118 and footrest 120. FIG. 8 shows the right side of coupling mechanism 118, but coupling mechanism 118 can include a left side as shown in FIG. 5 and FIG. 6. Adjustable leg support 116 can be used to hold legs of a user in place while seated. In particular, footrest 120 can provide a place to rest feet of a user to facilitate unencumbered operation of wheels 14. In the example, of FIG. 8, adjustable leg support 116 is attached to base section 12 and chair section 16 such that footrest 120 rotates and lifts with seat portion 18. However, adjustable leg support 116 can be attached to base section 12, as shown in FIG. 11.

As discussed with reference to FIG. 5 and FIG. 6, coupling mechanism 118 can comprise first strut 122B and second strut 124B. First strut 122B can be connected to seat frame 54 at connection point 126A and to footrest 120 at connection point 126B. Second strut 124B can be connected to right bar 82 at connection point 128A and to footrest 120 at connection point 128B. Although not illustrated, first strut 122A can be connected to seat frame 54 at a connection point and to footrest 120 at connection at a connection point, and second strut 124A can be connected to left bar 78 at a connection point and to footrest 120 at a connection point. Connection point 126A, connection point 128A, connection point 126B and connection point 128B can comprise pinned connections. In examples, connection point 126A can comprise a pin extending through first strut 122B and into right bar 82, connection point 128A can comprise a pin extending through second strut 124B and into top bar 44 (FIG. 3A), connection point 126B can comprise a pin extending through first strut 122B and into footrest 120, and connection point 128B can comprise a pin extending through second strut 124B and into footrest 120. Connection points for first strut 122A and second strut 124A can be configured similarly on the opposite side of mobility chair 10.

FIG. 9 is a schematic illustration of portions of mobility chair 10 of the present disclosure showing base section 12 surrounding toilet 130. Base section 12 can comprise front panel 22, left-side panel 24 and right-side panel 26, which can form internal space 47. Front panel 22 can include bottom bar 28, left-side panel 24 can include bottom bar 36, and right-side panel 26 can include bottom bar 42.

Wheel 48A can be connected to mobility chair 10 via spindle 140A and caster 142A. Wheel 48B can be connected to mobility chair 10 via spindle 140B and caster 142B. Wheel 48C can be connected to mobility chair 10 via spindle 140C and motor 144A. Wheel 48D can be connected to mobility chair 10 via spindle 140D and motor 144B.

Front panel 22, left-side panel 24 and right-side panel 26 can be configured to have an open back side to allow mobility chair 10 to backup over toilet 130. For example, a connecting member can be omitted between bottom bar 36 and bottom bar 42. Thus, the width of bottom bar 28 can be sized to allow bottom bar 36 and bottom bar 42 to fit alongside toilet 130 such that toilet 130 fits within internal space 47.

Wheel 48A and wheel 48B can be connected to base section 12 via caster 142A and caster 142B, respectively. Caster 142A and caster 142B can allow wheel 48A and wheel 48B to pivot or rotate relative to base section 12, e.g., orthogonally to spindle 140A and spindle 140B out of the plane of FIG. 9, to allow for turning of mobility chair 10 while rolling using wheels 14. In examples, electric motors can be connected to caster 142A and caster 142B to allow automated turning of wheel 48A and wheel 48B via user interface 156, for example.

Wheel 48C and wheel 48D can be connected to base section 12 via motor 144A and motor 144B, respectively. Motor 144A and motor 144B can comprise electrically activated motors that can cause rotation of wheel 48C and wheel 48D about spindle 140C and spindle 140D, respectively.

Motor 144A and motor 144B, as well as motors for caster 142A and caster 142B, can be connected to an electrical control system of mobility chair 10, as shown in FIG. 10.

FIG. 10 is a schematic illustration of electrical system 150 of mobility chair 10 of the present disclosure showing motor 144A, motor 144B, left-side actuator 52A, right-side actuator 52B, left-side actuator 62A, right-side actuator 62B, battery 152, controller 154 and user interface 156. Electrical system 150 can also include switch 158A, switch 158B, switch 158C, switch 158D, switch 158E, switch 158F and switch 158F.

Battery 152 can be mounted to mobility chair 10 in any suitable location using any suitable securing means. In examples, battery 152 can be mounted within internal space 47 in such a location to not interfere with toilet 130. Battery 152 can comprise any conventional single use or rechargeable battery, such as dry cell batteries, alkaline batteries, Li-Ion batteries, lead-acid batteries and the like.

Battery 152 can be placed in communication with left-side actuator 52A, right-side actuator 52B, left-side actuator 62A, right-side actuator 62B, motor 144A and motor 144B via switch 158A through switch 158F. Switch 158A through switch 158F can comprise electrically activated switches or breakers that can be user actuated, such as through user interface 156. Thus, a user of mobility chair 10 can operate user interface features, such as buttons, a touch pad, a joystick and the like to operate switch 158A through switch 158B. In examples, the pushing of a button can allow an actuator of the present disclosure to be fully extended or fully retracted. In examples, a button can be depressed and released to control extension of an actuator to intermediate positions. Switch 158A through switch 158B can comprise two-way switches to allow voltage to be applied to left-side actuator 52A, right-side actuator 52B, left-side actuator 62A, right-side actuator 62B, motor 144A and motor 144B in reverse polarities to allow bi-directional motion.

Electrical system 150 can additionally include sensors (now shown), such as proximity sensors, level sensors, position sensors and the like, that can be used to provide feedback to a user to determine correct positioning for seat portion 18. Output of the sensors can be used to provide audio and/or visual feedback to a user or to provide input to switch 158A through switch 158F to automate the operation of components connected thereto, such as left-side actuator 52A through right-side actuator 62B. In examples, rotational position sensors can be used to sense the relative positions of components connected to left-side actuator 52A, right-side actuator 52B, left-side actuator 62A and right-side actuator 62B. In examples, proximity sensors can be used to sense the relative position between seat portion 18 and base section 12 to determine height H1, distance D1 and distance D2.

FIG. 11 is a schematic illustration of mobility chair 210 of the present disclosure comprising another configuration. Mobility chair 210 can comprise base section 212, wheels 214 and chair section 216. Chair section 216 can comprise seat portion 218 and backrest portion 220. Base section 212 can be connected to chair section 216 by actuator system 217. Seat portion 218 can be connected to backrest portion 220 by actuator system 219.

Seat portion 218 can comprise seat pad 256, which can include cutout 259 to provide access to bedpan 261. Backrest portion 220 can comprise back pad 260. Wheels 214 can include wheel 248C, tilt wheel 248E and wheel 248G. In examples, mobility chair 210 can be configured as a tricycle with wheel 248G centered in the front of base section 212. In additional examples, a fourth wheel can be included, as shown, so that two front wheels are located at the sides of base section 212. Mobility chair 210 can additionally include stabilizer tube 255A, stabilizer tube 255B and stabilizer tube 255C. Stabilizer tube 255A can include footrest 257A and stabilizer tube 255B can include footrest 257B.

Mobility chair 210 can be configured similarly as mobility chair 10 of FIG. 1 through FIG. 9 in that mobility chair 210 comprises an actuator system and a pivot mechanism. Thus, seat portion 218 can be connected to backrest portion 220 via a hinge mechanism and seat portion 218 can be connected to chair section 216 via a plurality of linkages that provide two-stage pivoting and elevating action. Additionally, mobility chair 210 can be connected to a control system similar to what is shown in FIG. 10 to allow automation of various actuators and motors.

As discussed herein, actuator system 217 and actuator system 219 can be employed to change the shape of mobility chair 210 from a retracted or contracted position to an extended or deployed position to facilitate egress and ingress of a user from an elevated platform such as a bed. In particular, actuator system 217 can be used to raise and pivot chair section 216 relative to base section 212, and actuator system 219 can be used move the position of backrest portion 220 relative to seat portion 218. Thus, mobility chair 210 can be configured to move a patient between a typical seated position to a fully reclined position. In particular, mobility chair 210 can be wheeled to a location where backrest portion 220 faces toward a bed and base section 212 engages a side of the bed. Thereafter, backrest portion 220 can be reclined to rest on top of the bed to allow the user can slide themselves off of mobility chair 210 onto the bed and vice versa using their arms, thereby eliminating the need for assistance from another portion or reducing the input from another person.

In the example of FIG. 11, stabilizer tube 255A, stabilizer tube 255B and stabilizer tube 255C can comprise telescoping shafts that can extend and retract as seat portion 218 raises and lowers. Stabilizer tube 255A, stabilizer tube 255B and stabilizer tube 255C can prevent seat portion 218 from jostling or moving side-to-side or back-and-forth relative to base section 212.

In the example of FIG. 11, footrest 257A and footrest 257B are connected to stabilizer tube 255A and stabilizer tube 255B, respectively, such that footrest 257A and footrest 257B remain with base section 212 regardless of the position of chair section 216. Thus, footrest 257A and footrest 257B are immobile relative to movement of chair section 216, but can be adjustable to be compatible with different lengths of legs of users.

In the example of FIG. 11, mobility chair 210 can include bedpan 261 underneath seat pad 256. However, bedpan 261 can comprise an optional or removable component so that mobility chair 210 can be used with a toilet, such as toilet 130 of FIG. 9. Mobility chair 210 can be provided with an insert, such as toilet insert 57 of FIG. 1, to fill-in cutout 259 to provide a full seat cushion for a user.

The mobility chair of the present disclosure offers several benefits and advantages designed to enhance the autonomy and quality of life for users, particularly those with limited mobility. The mobility chair of the present disclosure also solves problems associated with previous wheelchair designs. Some of the benefits and advantages and solutions to problems are listed below.

Enhanced Autonomy: The chair allows users to enter and exit at their own volition, particularly from a reclined position such as from a bed. This feature significantly enhances the independence of the user by reducing reliance on caregivers for mobility.

Ease of Use: The chair is designed to facilitate easy transitions between sitting in the chair and other activities such as using a toilet or lying in bed. This can be achieved through features like an adjustable height seat portion, an adjustable incline backrest portion, and a base section having an open-back design.

Reduced Physical Strain: The chair minimizes the need for physical contortion or upper body and lower body strength to enter or exit, which is particularly beneficial for users with limited mobility and strength in their upper and lower limbs.

Cost Efficiency: By reducing the need for constant caregiver assistance, the chair can potentially lower the costs associated with caregiving services.

Comfort and Convenience: The chair design and configuration addresses common discomforts associated with waiting for assistance, providing users the ability to move at their preferred times, such as when needing to use the restroom or transitioning to sleep.

Integrated Toilet Use: The mobility chair can be maneuvered over a toilet, allowing the user to utilize the toilet without needing to leave the chair, thereby enhancing both the dignity and independence of the user.

Versatile Mobility: Equipped with a base section that includes multiple wheels and actuators, the chair can navigate various environments and be adjusted for different activities and needs.

Safety Features: The design includes mechanisms that lock the wheels to prevent undesired movement during transfers, enhancing the safety of the user during the use of the mobility chair.

Technical Innovations: The chair includes various technical components such as motors, actuators, a battery, a controller, and a user interface, which together support complex movements and adjustments of the chair, providing a seamless experience for the user.

Overall, the mobility chair is designed to significantly improve the quality of life for individuals with mobility challenges, offering them greater freedom, safety, and independence in their daily activities. In examples, this can be achieved with actuator systems and pivot mechanisms that allow the chair to transition from a fully contracted state for a seated position to a fully extended state for a reclined position through a multi-stage deployment sequence.

### EXAMPLES

Described implementations of the subject matter can include one or more features, alone or in combination as illustrated below by way of examples.

Example 1 is a mobility chair comprising: a base section; a set of wheels connected to the base section to allow the base section to traverse a surface; a chair section connected to the base section, the chair section comprising: a seat portion pivotably connected to the base section; and a backrest portion pivotably connected to the seat portion; and an actuator system configured to: move the seat portion relative to the base section; and move the backrest portion relative to the seat portion.

In Example 2, the subject matter of Example 1 optionally includes wherein the seat portion and the base section are connected by a pivot mechanism configured to allow the seat portion to pivot and elevate relative to the base section.

In Example 3, the subject matter of Example 2 optionally includes wherein the pivot mechanism comprises: a left-side pair of pivot arms connecting the seat portion and the base section; and a right-side pair of pivot arms connecting the seat portion and the base section.

In Example 4, the subject matter of Example 3 optionally includes wherein the left-side pair of pivot arms and the right-side pair of pivot arms each comprise: a front pivot arm connecting the seat portion and the base section; and a rear pivot arm connecting the seat portion and the base section; wherein: the front pivot arm and the rear pivot arm are connected to the base section a first distance apart from each other; the front pivot arm and the rear pivot arm are connected to the seat portion a second distance apart from each other; and the second distance is greater than the first distance.

In Example 5, the subject matter of any one or more of Examples 2-4 optionally include wherein the pivot mechanism comprises a hinge connecting the seat portion and the base section.

In Example 6, the subject matter of Example 5 optionally includes wherein the hinge and the actuator system allow the backrest portion to pivot below a plane of the seat portion.

In Example 7, the subject matter of any one or more of Examples 5-6 optionally include wherein the pivot mechanism allows the seat portion to be declined backward relative to the base section.

In Example 8, the subject matter of any one or more of Examples 1-7 optionally include wherein the actuator system comprises: a first actuator extending between the seat portion and the base section; and a second actuator extending between the seat portion and the backrest portion.

In Example 9, the subject matter of Example 8 optionally includes wherein the second actuator comprises a portion of an armrest.

In Example 10, the subject matter of Example 9 optionally includes wherein; the armrest comprises a vertical support extending from the seat portion and a horizontal arm pad; the first actuator extends between the vertical support and the backrest portion to support the horizontal arm pad; and the horizontal arm pad is connected to the first actuator.

In Example 11, the subject matter of any one or more of Examples 8-10 optionally include a controller configured to operate the first actuator and the second actuator; wherein the first actuator and the second actuator comprise electric linear actuators.

In Example 12, the subject matter of any one or more of Examples 8-11 optionally include a third actuator extending between the seat portion and the base section; and a fourth actuator extending between the seat portion and the backrest portion.

In Example 13, the subject matter of any one or more of Examples 1-12 optionally include wherein the base section allows the seat portion to be positioned over a toilet.

In Example 14, the subject matter of Example 13 optionally includes wherein the base section comprises: a front panel; a right-side panel; and a left-side panel.

In Example 15, the subject matter of Example 14 optionally includes wherein the base section comprises: an open back side; and an internal space between the front panel, the right-side panel and the left-side panel in which the toilet can fit.

In Example 16, the subject matter of any one or more of Examples 1-15 optionally include wherein the seat portion comprises: a seat pad; and a removable toilet insert positioned within the seat pad.

In Example 17, the subject matter of Example 16 optionally includes a bedpan positioned underneath the removable toilet insert.

In Example 18, the subject matter of any one or more of Examples 1-17 optionally include a leg rest device to support feet of a user seated in the chair section.

In Example 19, the subject matter of Example 18 optionally includes wherein the leg rest device is connected to the chair section to move with the chair section via operation of the actuator system or wherein the leg rest device is connected to the base section to be immobile.

In Example 20, the subject matter of any one or more of Examples 1-19 optionally include a backrest support bar protruding from the backrest portion to provide support for the backrest portion against a horizontal surface when the backrest portion is rotated at a decline relative to the chair section.

Example 21 is a method of lifting a user from a mobility chair onto a surface, the method comprising: pivoting a seat portion of a chair section relative to a base section; elevating the seat portion relative to the base section; and reclining a backrest portion of the chair section relative to the seat portion.

In Example 22, the subject matter of Example 21 optionally includes positioning the mobility chair adjacent to a bed such that the base section is positioned proximate a side of the bed and the backrest portion faces toward the bed.

In Example 23, the subject matter of Example 22 optionally includes reclining the backrest portion such that it extends beyond a horizontal position to contact a top surface of the bed.

In Example 24, the subject matter of any one or more of Examples 22-23 optionally include engaging a side of the bed with the base section of the mobility chair to ensure close proximity for user transfer; and locking wheels on the base section to stabilize the mobility chair.

In Example 25, the subject matter of any one or more of Examples 21-24 optionally include activating a first actuator system to pivot the backrest portion relative to the seat portion; and activating a second actuator system to pivot the seat portion relative to the base section.

In Example 26, the subject matter of Example 25 optionally includes simultaneously activating the first actuator system and the second actuator system.

In Example 27, the subject matter of any one or more of Examples 25-26 optionally include wherein activating the first actuator system comprises: extending a first set of actuators connected between the seat portion and the backrest portion; and adjusting an angle of the backrest portion relative to the seat portion to perform the reclining.

In Example 28, the subject matter of Example 27 optionally includes wherein activating the second actuator system comprises: extending a second set of actuators connected between the base section and the seat portion; and raising the seat portion to a height above the base section to align the seat portion with or elevate the seat portion above a bed surface.

In Example 29, the subject matter of Example 28 optionally includes retracting the first set of actuators and the second set of actuators to return the mobility chair to a contracted state after the user has been transferred to a bed.

In Example 30, the subject matter of any one or more of Examples 25-29 optionally include controlling the pivoting, elevating and reclining via a user interface that is configured to receive input from the user and sends commands to the first actuator system and the second actuator system.

### Various Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A mobility chair comprising:
a base section;
a set of wheels connected to the base section to allow the base section to traverse a surface;
a chair section connected to the base section, the chair section comprising:
a seat portion pivotably connected to the base section; and
a backrest portion pivotably connected to the seat portion; and
an actuator system configured to:
move the seat portion relative to the base section; and
move the backrest portion relative to the seat portion.

2. The mobility chair of claim 1, wherein the seat portion and the base section are connected by a pivot mechanism configured to allow the seat portion to pivot and elevate relative to the base section.

3. The mobility chair of claim 2, wherein the pivot mechanism comprises:
a left-side pair of pivot arms connecting the seat portion and the base section; and
a right-side pair of pivot arms connecting the seat portion and the base section.

4. The mobility chair of claim 3, wherein the left-side pair of pivot arms and the right-side pair of pivot arms each comprise:
a front pivot arm connecting the seat portion and the base section; and
a rear pivot arm connecting the seat portion and the base section;
wherein:
the front pivot arm and the rear pivot arm are connected to the base section a first distance apart from each other;
the front pivot arm and the rear pivot arm are connected to the seat portion a second distance apart from each other; and
the second distance is greater than the first distance.

5. The mobility chair of claim 2, wherein the pivot mechanism comprises a hinge connecting the seat portion and the base section.

6. The mobility chair of claim 5, wherein the hinge and the actuator system allow the backrest portion to pivot below a plane of the seat portion.

7. The mobility chair of claim 5, wherein the pivot mechanism allows the seat portion to be declined backward relative to the base section.

8. The mobility chair of claim 1, wherein the actuator system comprises:
a first actuator extending between the seat portion and the base section; and
a second actuator extending between the seat portion and the backrest portion.

9. The mobility chair of claim 8, wherein the second actuator comprises a portion of an armrest.

10. The mobility chair of claim 9, wherein;
the armrest comprises a vertical support extending from the seat portion and a horizontal arm pad;
the first actuator extends between the vertical support and the backrest portion to support the horizontal arm pad; and
the horizontal arm pad is connected to the first actuator.

11. The mobility chair of claim 8, further comprising:
a controller configured to operate the first actuator and the second actuator;
wherein the first actuator and the second actuator comprise electric linear actuators.

12. The mobility chair of claim 8, further comprising:
a third actuator extending between the seat portion and the base section; and
a fourth actuator extending between the seat portion and the backrest portion.

13. The mobility chair of claim 1, wherein the base section allows the seat portion to be positioned over a toilet.

14. The mobility chair of claim 13, wherein the base section comprises:
a front panel;
a right-side panel; and
a left-side panel.

15. The mobility chair of claim 14, wherein the base section comprises:
an open back side; and
an internal space between the front panel, the right-side panel and the left-side panel in which the toilet can fit.

16. The mobility chair of claim 1, wherein the seat portion comprises:
a seat pad; and
a removable toilet insert positioned within the seat pad.

17. The mobility chair of claim 16, further comprising a bedpan positioned underneath the removable toilet insert.

18. The mobility chair of claim 1, further comprising a leg rest device to support feet of a user seated in the chair section, wherein the leg rest device is connected to the chair section to move with the chair section via operation of the actuator system.

19. The mobility chair of claim 1, further comprising a backrest support bar protruding from the backrest portion to provide support for the backrest portion against a horizontal surface when the backrest portion is rotated at a decline relative to the chair section.

20. A method of lifting a user from a mobility chair onto a surface, the method comprising:
pivoting a seat portion of a chair section relative to a base section;
elevating the seat portion relative to the base section; and
reclining a backrest portion of the chair section relative to the seat portion.
